(19) United States
(12) Patent Application Publication
(10) Pub. No.: US 2017/0329295 A1
(43) Pub. Date: Nov. 16, 2017

(54) PRODUCTION MODULE FOR IMPLEMENTING A PRODUCTION FUNCTION ON A PRODUCT

(71) Applicant: Siemens Aktiengesellschaft, Muenchen (DE)

(72) Inventor: Vladimir ZAHORCAK, Borinka (SK)

(21) Appl. No.: 15/590,615

(22) Filed: May 9, 2017

(30) Foreign Application Priority Data
May 10, 2016 (EP) 16168897

(51) Int. Cl. G05B 17/02; G06F 17/50; G06Q 10/06; G06N 5/02; G06N 99/00; G06Q 10/08; G06F 19/26

(52) U.S. Cl. CPC G05B 17/02; G06N 5/025; G06F 17/5004; G06N 99/005; G06Q 10/06316; G06F 19/26; G06F 17/50; G06Q 10/08

(57) ABSTRACT

A method for simulation of an industrial production plant, wherein a plurality of production modules are assembled to form a plant layout of the production plant to be simulated, where a first production module is represented by a simulation on a first device and a second production module is represented by a simulation on a second device, where for simulation of a production sequence, a computer-generated product model is transferred to the first production module and, according to production-specific features of the first production module, a first production function is applied to a product model and the product model is transferred to the second production module, and a second production function is applied to the product model in the second production module.

### BACKGROUND OF THE INVENTION

### 1. Field of the Invention

The present invention relates to a method for simulation of an industrial production plant, where a plurality of production modules will be assembled to form a plant layout of the production plant to be simulated.

### 2. Description of the Related Art

Simulation methods are generally known. The Masters Thesis “DEPlaTa—A Digitally Enhanced Planning Table for Rough Factory Layouts” by Nico Herbig, dated September 2015, thus discloses Intuplan, for example, which is an intuitive planning tool for a plant layout

A disadvantage of the prior art is that a relatively large amount of involvement of a user is required in the creation of such a plant layout, i.e., production models must be printed with a 3D printer and pieced, for example. In addition, they must also be provided with a OR code and photographed.

### SUMMARY OF THE INVENTION

In view of the foregoing, it is therefore an object of the present invention to simplify the simulation of an industrial plant.

This and other object an advantages are achieved in accordance with the invention by a method for simulation of an industrial production plant, where a number of production modules will be assembled to form a plant layout of the production plant to be simulated, portable, mobile electronic devices with a display unit will be used as production modules, which make it very simple for a user, for example, to lay tablet PCs or smartphones against one another in order to map a plant layout to be developed. Simulation software will be executed on the devices and the simulation software on the respective device is able to be adapted by a user input to production-specific features of the production module representing this device, such as a robot, an assembly line, a lathe, or a test system, where a first production module will be represented by a simulation on a first device and a second production module by a simulation on a second device, where, for simulation of a production sequence, a computer-generated product model will be transferred to the first production module and in accordance with the production-specific features of the first production module a first production function will be applied to the product model and the product model will be transferred to the second production module, and where a second production function will be applied to the product model in the second production module.

In order to simulate the plant layout, such as on a large table, the procedure is as follows:

a) positioning the first production module at a first position, where a coordinate origin will be formed by this first position of the first production module, where each portable, mobile electronic device has a left contact side, a right contact side, an upper contact side and a lower contact side and

b) depending on the production-specific features of the first production module, possible contact sides, i.e., where a virtual product leaves the production module and moves to the next production module, will be displayed on the display unit of the first production module, via a touch object, the touch object is then an arrow, for example, which can be tapped with a finger to initiate a function,

c) positioning the second production module as a neighbor to the first production module, where, depending on the production-specific features of the second production module, likewise possible contact skies will be displayed via of further touch objects on the display unit of the second production module, placing a contact side of the second device marked by a touch object on a contact side of the first device marked by a touch object,

d) actuating both touch objects from the contact sides now facing towards each other, through which a second position of the second production module in relation to the coordinate origin will be defined, and

f) positioning the further production modules in a similar way to that described under steps c) and d) until the desired plant layout is reached.

After all devices are positioned and are preferably linked to one another via wireless communication, a contiguous simulated production of a virtual product could start, The virtual product or the virtual workpiece then passes through the simulated production process and thus moves from one mobile device to the next mobile device, where the virtual workpiece will be visible on each display of the mobile devices. The production function that is currently being applied to the virtual workpiece could also be shown on the devices, The virtual workpiece or the virtual product can thus be traced along the path from a first production module to a last production module.

A user can easily verify whether the simulated industrial production plant is correctly producing the planned product. He/she can also read off information about Key Performance Indicators (KPI) or performance figures at the devices, e.g., production time or overall energy consumption. The simulation of the industrial production plant can be started for different products and can also be flexibly adapted or changed by repositioning the devices, in order to test different plant layouts.

A mobile device representing a production module is configured to implement the production function on the product model and is further configured to couple with a second production module. The second production module is again configured to implement the second production function on the product model. In such cases, first self-description information relating to properties of the first production module is stored in a first memory device of the first production module and furthermore the second production module includes second self-description information relating to properties of the second production module. The first production module is configured to transfer the first self-description information to the second production module and to receive the second self-description information from the second production module. Port information relating to the coupling with further production modules is also stored in the memory device of the respective production module.

The presence of the self-description information of the first and second production module and the option of being able to transmit the information from one to the other and the simultaneous presence of port information relating to the coupling with the second production module in the first production module means that both information about the capabilities of the modules and also information about a coupling with the second production module is available in the production module. This enables the first production module, for example, to be moved into a location for working together with the second production module for the handling or processing of a product with relatively little or even without user involvement. In this way, the set up of a production plant to be simulated, comprising the two production modules, for example, will be simplified.

The production modules can simulate a very wide diversity of mechanical, electromechanical or electronic devices, which are configured to handle, move, process and/or work on an object, workpiece, a fluid or comparable products, assemblies or materials. Production modules can, for example, be machine tool modules, processing machines (e.g. for milling, drilling, punching, or pressing) or similar tools, devices or machines or also elements thereof. Furthermore production modules can also be configured for at least functions such as transport of products, assemblies or materials, for example, as a conveyor belt, crane, robot arm, pump or similar. Furthermore, production modules can also be configured to store or feed corresponding products (e.g., comprising a shelving system, or tank). The production module can also be configured, for example, to heat up or also work in some other way on workpieces, assemblies and/or solid, liquid or gaseous materials, e.g., as an oven, vessel, valve, or stirrer.

The production module itself can, for its part, be constructed from a number of sub-modules and/or, for example, simulate one or more mechanical and/or electronic subunits.

A production module can, for example, be configured as a control unit or a controller for control of the production function and/or of the methods, processes and determinations described in the present description in relation to the production module. Furthermore, the production module can include one or more communication interfaces as well as one or more memory devices for storing of data and/or information. For implementing the production function, the production module can also simulate corresponding mechanical, electrical, electronic and/or electromechanical or optical components.

In particular, the production module can simulate a so-called “Cyber-Physical System” (CPS) or a part thereof. Thus, the production module can, for example, simulate a “Cyber-Physical Module” (CPM) or a “Cyber-Physical Production Module” (CPPM) for a simulation.

A production function, within the framework of the present description, is generally to be understood as each process, which is implemented or which can be implemented within the framework of production, manufacturing, processing, handling or working on an object, a material or a substance. A production function in this case can be any possible working step relating to any given product, from the initial substances through to the finished end product, for example.

For example, a production function can include working in any way on a type of material (e.g., milling, drilling, grinding, pressing, lacquering, molding, pumping, heating-up, moving, opening, or closing), any type of transport or movement or handling of an object, an assembly, a material or a substance or such processes. Furthermore, the production function can, for example, comprise a storage, diagnosis, testing, optical recording, measuring, determination of a shape, location or size or similar functionalities, or such functionalities.

A product can be simulated, for example, as a mechanical, optical, electromechanical, electronic or comparable product or product model. Furthermore, the product can be simulated, for example, as a workpiece, an assembly, a solid, liquid or gaseous material, a solid, liquid or gaseous chemical or similar as a product model.

Within the framework of the present description, the term “product” will be used as an abstract description of an entirely variable object within the framework of a production or working. A “product” in the sense of the present description can change entirely in its external or internal appearance or embodiment during the course of a production process, such as through the effect of production functions.

The coupling of the first production module with the second production module can be configured such that the first production function of the first production module and the second production function of the second production module can interact or do interact. Such an interaction of production functions can, for example, be jointly working on a product, working on and transporting a product or also a handover of a product from one transport unit to a further transport unit. To this end, two production modules can, for example, be located in a suitable geometrical arrangement and, e.g., be electronically coupled such that the interaction of the production functions is made possible or is implemented or is able to be implemented.

The coupling of the first production module with the second production module or generally the coupling of two neighboring production modules can be configured, for example, as a communicative coupling via corresponding hard-wired or wireless communication interfaces (e.g., via Ethernet, Profinet, Profibus, field busses, WLAN, Bluetooth, or NFC) or can include such a communicative coupling.

The second production module can be configured, for example, in a corresponding manner to the first production module described in the present description. Furthermore, the production modules can each be coupled with further production modules, which for their part can each be configured in a corresponding manner to a production module or a first production module in accordance with the present description. In such cases, the coupling with the other production modules in each case can also be configured as described in greater detail in the present description.

The self-description information relating to the properties of the production module can, for example, include the widest variety of information relating to the production function of the production module. In particular, for example, the self-description information can include an identification or characterization of the functionality or functionalities, which is realized or are realized in the production function. Furthermore, the self-description information can include information about materials or objects to be worked on or processed, information about size, shape, weight or similar specifications or conditions, information about one or more working areas of the production module, information about quality criteria, results and/or prerequisites relating to the production function or the corresponding working results or products or similar information relating to the production function.

The self-description information can additionally include information about other properties of the production module, such as a size, a geometry, a location, an identification code, a layout, a configuration, available services and functionalities, connected devices, modules and/or assemblies, available control and other commands as well as available communication interfaces, corresponding communication parameters (MAC address or the like) and/or status information relating to the production module.

The self-description information relating to the properties of the second production module as well as also relating to further production modules mentioned in the present description can be configured in accordance with the information given here.

The transmission of the self-description information between the production modules, for example, can occur or be configured as hard-wired and/or wireless communication. Such transmission can for example take place via Ethernet, field busses, WLAN, Bluetooth, NFC, optically or be configured or in a similar way. For the coupling of the second production module with the first, for example, there can be provision for the second self-description information of the second production module to be sent to the first production module, Furthermore, the first self-description information of the first production module can also be sent to the second production module, There can also be provision for an exchange of the position-description information between production module and second production module.

The port information relating to the coupling with the second production module stored in the first production module can include information, for example, about the second production function of the second production module. Furthermore, the port information can include information about an interaction of the production function of the production module and the second production function of the second production module, Such information can, for example, be information about a handover area or interaction area in which, for example, a product must or can be located in order to make possible such an interaction of the production functions.

Such interactions can, for example, be jointly working on a product, working on a product located in a transport module or the handover between two transport modules.

Furthermore, the port information can also include information about further production functions and/or functionalities, able to be reached via the second production module. Such information about such further modules or production functions can correspond to the information given here relating to the second production module.

Furthermore, the production module can also be coupled directly with one or more further production modules in accordance with the present description, where there can further be provision that for each of the further production modules linked directly to the production module, corresponding port information relating to the coupling with the respective production module will be or is stored in the production module. This port information can be configured in a corresponding manner to the port information relating to the coupling with the second production module described, here.

The port information relating to the coupling with the second or also with further production modules can be established, for example, in the production module, or also in an external computer or a comparable device, and then be transmitted to the production module. To “establish” here is to be understood, for example, as a pure extraction of data from corresponding messages or the reading-out of corresponding information data, but also as the processing of transferred or transmitted data or information.

In an advantageous embodiment, the port information relating to the coupling with the second production module can include information about a spatial interaction area of the production module with the second production module, where the spatial interaction area is characterized in that both the production function of the first production module and also the second production function of the second production module can act on the product when it is located in the interaction area.

The information about the interaction area can make it possible, for example, for the production modules to work together with reduced or even with no user involvement, because the spatial area in which the product or material to be worked on or to be handled must be located is known to the production module, in order to be worked on or handled both by itself and also by the second production module. In this way, the set up and operation of a corresponding production system will be further simplified.

In particular, there can be provision for the interaction area to be established or to be able to be established based on the self-description information of the first production module as well as the second self-description information of the second production module. This area can be established, for example, in the production module, in the second production module and/or in an external computer or similar device.

For this purpose, a working area of the respective production modules can be stored, for example, in the respective self-description information and then the interaction area can be established using the knowledge of the respective working areas as well as the relative location of the production modules in relation to one another. In such cases, the information about the relative position of the production modules can be predetermined or able to be predetermined, for example, or can also be established automatically or by a user.

The port information can then, for example, include information about a geometry of the interaction areas and/or a position of the interaction areas. In such cases, geometry and/or position can be stored in corresponding module coordinates or in another coordinate system, such as a joint coordinate system for both production modules.

For a later real production with a real production plant and real production modules it is very advantageous, when the simulation has reached a target status, to transfer the parameters and the settings obtained during the simulation of at least one of the following items of information:
the self-description information,
the service information,
the configuration information,
the capability information,
the command information,
the status information,

to store them and to use them for the further real production.

If the complete storage area of the information and parameters listed above is considered as a software stack, then it is very sensible to transfer this software stack or the individual software stacks of the different production modules into later real “Cyber-Physical Systems”.

Because of the reusability of the software stacks, it is likewise possible to integrate reel “Cyber-Physical Modules”, which are structured in exactly the same way in respect of the software stacks, into a plant layout to be simulated or vice versa and in this way to use a mixture or real and simulated modules for a development/further development and commissioning of real production plants.

In particular, a position of the interaction areas can be specified and/or stored for example in corresponding module coordinates or also a further coordinate system, such as a joint coordinate system of the modules. The same applies to geometry, e.g., the spatial embodiment, of the interaction areas.

In an advantageous embodiment, the port information stored in the production module relating to the coupling with the second production module can include information relating to properties of further production modules linked directly and/or indirectly to the second production module. In particular, the port information stored in the production module relating to the coupling with the second production module can include information relating to production functions of production modules linked directly and/or indirectly to the second production module.

In this way, the layout and the operation of a production plant comprising such production modules can be further simplified, in that, with a product located in a specific production module, it can already be recognized via the port information relating to a coupled second production module, which further production modules and/or production functions are available or able to be reached via a coupling or interaction with the second production module.

In such cases, properties of further production modules linked to the second production module can be such properties as are described in greater detail elsewhere in the present description, for example, in relation to self-description information of a production module.

In particular, the port information relating to the coupling with the second production module can include properties relating to all further production modules linked directly and/or indirectly to the second production module. Furthermore the stored information relating to the properties of the further production modules can also include specific categories of production modules, technical restrictions, spatial restrictions or also functional restrictions.

In such cases, further production modules linked directly to the second production module are such modules as have a direct coupling or link to the second production module available to them. Indirectly linked further production modules are those that do not have any direct coupling to the second production module, but in their turn are able to be reached via other production modules from the second production module.

Two production modules are directly linked when the modules are “effectively” linked for example, i.e., when, for example, their production functions in accordance with the present description (as already explained) interact or can interact. In particular, they are directly linked when they are or will be coupled in accordance with the present disclosed embodiments. Thus for example two linked transport modules make possible end-to-end transport of a product with a corresponding handover between the modules. A working unit linked to a further module can then, for example, make it possible to work on a product located in another module or can make it possible to work jointly with the other module.

Furthermore, the self-description information stored in the production module in accordance with the present embodiments can include configuration information relating to a location and/or embodiment of the production module.

The self-description information can also include capability information relating to available functions and services of the production module, where this can include information about the production function, for example.

Furthermore, the self-description information can also include command information relating to commands able to be executed or understood by the production module, as well as parameters that are able to be set or that have been set.

In addition, the self-description information can also include status information relating to a working status. In such cases, a working status can, for example, include a current operating status (fully functionally active, partly functionally active, inactive, or emergency operation) or also information relating to errors and warnings that have occurred or similar status information can furthermore include information about a product present in or at the production module (e.g., a corresponding product ID, a current working status, or a current position within the production module).

The configuration information of the production module can, for example, include a position, a functional embodiment and/or a geometrical embodiment of the production module. Furthermore, the configuration information of the production module can also include an available and/or accessible spatial working area or a physical and other environment (e.g., neighboring modules, machines, or safety areas).

The port information stored in the production module relating to the coupling with the second production module can include information relating to properties of a third production module coupled with the second production module, where the third production module is coupled with the second production module, third self-description information relating to properties of the third production module is stored or is able to be stored in the third production module and the third production module is configured to perform a third production function on the product.

In such cases, the information relating to the properties of the third production module coupled with the second production module can include information relating to the third production function of the third production module and furthermore the coupling of the third production module with the second production module can be embodied in accordance with the coupling between production module and second production module explained in the present description. The self-description information of the third production module or of the third production function of this module can furthermore be configured in accordance with the corresponding information or functions of the production module or second production module in accordance with the present disclosed embodiments.

Information about the third production module can for example reach the production module by, e.g., the self-description information or parts thereof being transmitted via the second production module to the production module and being stored there, within the framework of the stored port information, as a whole, in extracts or after being correspondingly worked on or processed.

Furthermore, there can also be provision for further or also all production modules linked indirectly or directly to the second production module to include this type of self-description information and for this to be able to be transmitted or to be transmitted via the second production module to the production module. In this way, corresponding information about these further production modules can likewise be stored in the port information relating to the coupling with the second production module, In this way, information about functionalities, properties, statuses or further parameters of a number of production modules or also all production modules still accessible via the second production module can likewise be available in the production module.

This makes possible a further simplified simulation or a further simplified design of a plant layout consisting of such production modules, because in this way an improved planning over further production steps, which are to be performed with a product located in the production module, is possible.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention will be explained in greater detail below by way of examples, which refer to the enclosed drawings, in which:

FIG. 1 shows a plant layout for simulating a production plant with mobile electronic devices as assembled production modules in accordance with the invention;

FIG. 2 shows two production modules arranged alongside one another to illustrate the touch objects that can be actuated in accordance with the invention;

FIG. 3 shows a schematic embodiment of a production module in a mobile electronic device with a display unit in accordance with the invention;

FIG. 4 shows an example for layout, data and communication structure of a production system constructed from production modules in accordance with the invention;

FIG. 5 shows a more detailed example for a data structure of a production module in accordance with the invention;

FIG. 6 shows an example for a combination of a robot with a transport module in accordance with the invention;

FIG. 7 shows a schematic structure of the example of a production system depicted in FIG. 6 in accordance with the invention;

FIG. 8 shows an example for the method execution sequence during the coupling of two production modules in accordance with the invention;

FIG. 9 shows examples for planar arrangement structures of production modules to form a production system in accordance with the invention;

FIG. 10 shows a more detailed schematic diagram of the production system shown in FIG. 9 with a square arrangement; and

FIG. 11 is a flow chart of the method in accordance with the invention.

### DETAILED DESCRIPTION OF THE EXEMPLARY EMBODIMENTS

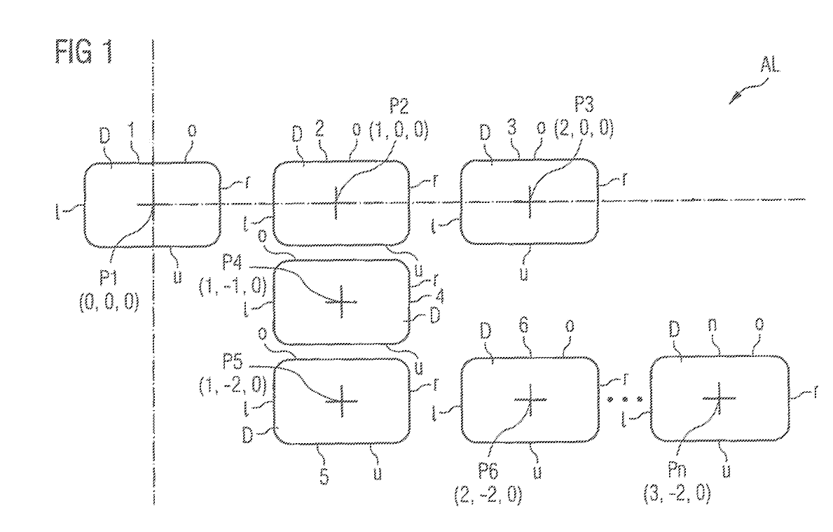

In accordance with FIG. 1, a plant layout AL is shown assembled from production modules 1, 2, . . . ,n in a coordinate system with a coordinate origin 0. A first production module 1 is placed in the coordinate origin 0 with a first position P1 (0,0,0). The first production module 1 as well as all other production modules 2, . . . ,n, formed as mobile electronic devices, as well as a display unit d, has a left contact side l, a right contact side r, an upper contact side o and a lower contact side u. Arranged on the right contact side r of the first production module 1 is a second production module 2 with its left contact side l. The second production module 2 thus assumes a second position P2 (1,0,0) in the coordinate system. Arranged on the right contact side r of the second position module 2 is a third position module 3 with its left contact side l. The third position module 3 thus assumes a third position P3 (2,0,0) in the coordinate system.

Arranged on the lower contact side u of the second production module 2 is a fourth production module 4 with its upper contact side o. The fourth position module 4 thus assumes a fourth position P4 (1,−1,0) in the coordinate system. Arranged on the lower contact side u of the fourth position module 4 is a fifth position module 6 with its upper contact side o. The fifth position module 5 assumes a fifth position P5 (1,−2,0), Arranged on the right contact side r of the fifth position module 5 is a sixth position module 6 with its left contact side l. The sixth production module 6 assumes a sixth position P6 (2,−2,0) in the coordinate system. Starting from the sixth production module 6, any given number of production modules Pn can now be placed in a row, on the right contact side r of the already placed production modules, in each case.

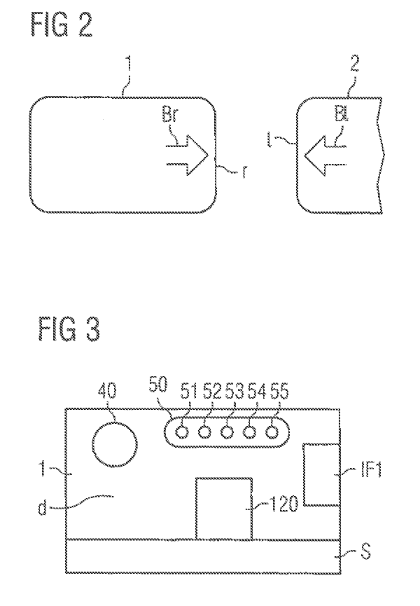

With the production modules 1, . . . ,n placed or positioned in this way, by arranging tablet computers next to one another, for example, a plant layout AL, as is to exist later in reality, will be assembled. Starting from the first production module 1, which was positioned at the coordinate origin 0, the second production module 2 will be placed as a neighbor to the first production module 1 with its left contact side l against the fight contact side r of the first production module 1. The display units D of the production modules 1, . . . ,n, depending on the production-specific features of the production modules 1, . . . ,n, show the possible contact sides l, r, o, u via touch objects Br, Bl (see FIG. 2).

In accordance with FIG. 2, the display of a right-side touch object Br and a left-side touch object Bl is indicated by way of example on the first production module 1 and the second production module 2, where the right-side touch object Br belongs to the first position module 1 and the left-side touch object Bl to the second position module 2, The touch objects Br, Bl will be represented, for example, as arrows directed towards one another on the display units D of the production modules 1, . . . ,n. The production modules 1, . . . ,n are embodied for example as a fiat tablet PC. As a result, the display unit d of the tablet PC has a touch screen. On actuation of both touch objects Br, Bl from the contact sides l, r now facing towards each other, the second position P2 of the second production module 2 will be defined in relation to the coordinate origin O. For the definition of the further positions P3, . . . ,Pn touch objects will in their turn be displayed on the possible contact sides l, r, o, u of the remaining production modules P3, . . . ,Pn in the display units D, in each case. A planner of the plant layout AL to be simulated must now touch the touch screens of the production modules 1, . . . ,n the contact sides l, r, o, u directed towards each other, in each case at which the touch objects Br, Bl appear and thus define the positions of each individual production module in relation to the coordinate origin 0.

In accordance with HG. 3, a production module 1 with a schematic structure is shown. The production module 1 has simulation software S, where the simulation software can access first self-description information 120. A product model 40 is present in the first production module 1 which, after being worked on, can be passed on to further production modules. In order to adapt the production module 1 by user inputs to production-specific features of the production module representing this device, a field for user inputs 50 is present. The field for user inputs 50 has a first touch button 51, such as for setting a robot, a second touch button 52, such as for setting a transport belt, a third touch button 53, for example for setting a drill, a fourth touch button 54, such as for setting an assembly segment and a fifth touch button 55, and such as for setting a device to text operation.

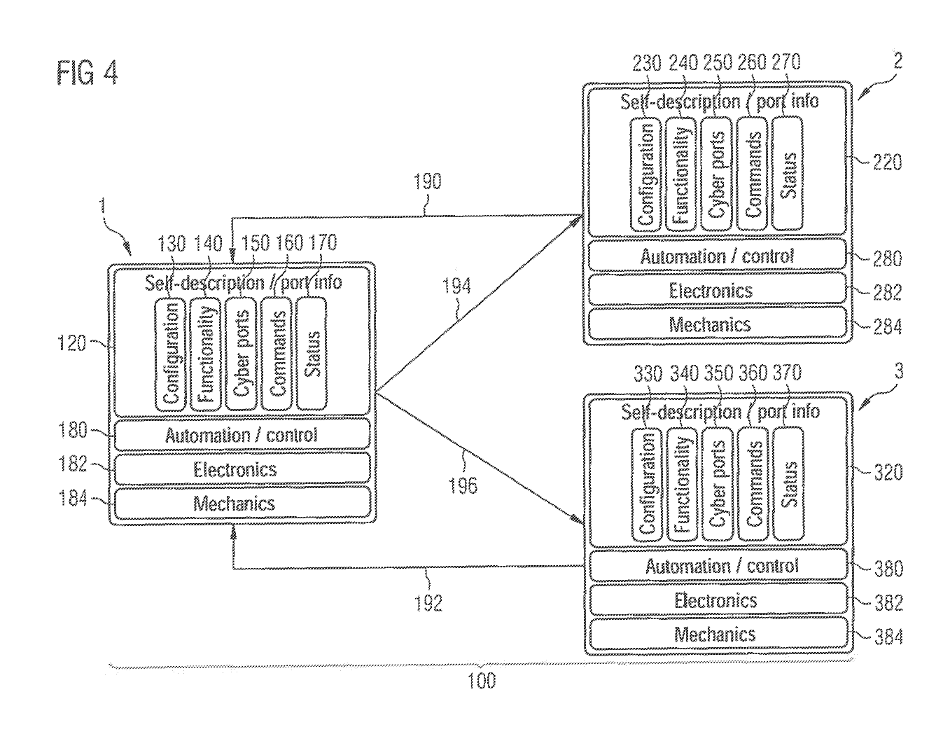

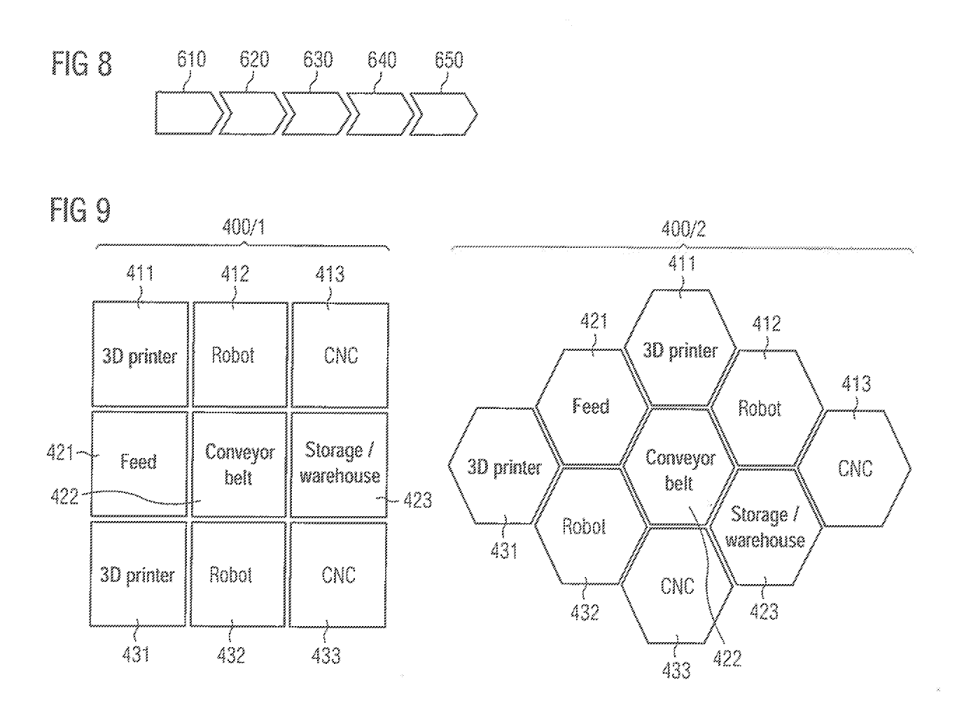

FIG. 4 shows a schematic layout of a coupling of three production modules 1, 2, 3. For each of the production modules 1, 2, 3 a layout of the production modules is shown schematically, In this case, the production modules 1, 2, 3 each include self-description information 120, 220, 320, where port information 150, 250, 350 is stored in each case in a memory area of the self-description information 120, 220, 320 of the respective production modules 1, 2, 3 relating to “Cyber-Physical Ports” present in the respective module. The port information 150, 250, 350 shown in FIG. 4 is an example for port information in accordance with the present description. Furthermore, the memory area 120, 220, 320 of the respective production modules 1, 2, 3 each include configuration information 130, 230, 330 relating to a functional as well as electronic, mechanical and communicative configurations and also to properties of the respective module. Furthermore, the memory area of the self-description information 120, 220, 320 of the respective production modules 1, 2, 3 includes a functionality description 140, 240, 340 of the respective module, a description of available commands 160, 260, 386, and also one or more items of status information 170, 270, 370 relating to the respective module 110, 210, 310. The configuration information 130, 230, 330, the service information descriptions 140, 240, 340 or the functionality, the descriptions of available commands 160, 260, 360 and status information 170, 270, 370 are each examples for self-description information in accordance with the present description. The self-description information or port information mentioned here will be explained in greater detail by way of examples in conjunction with FIG. 8.

Furthermore, each of the production modules 1 2, 3 includes an automation and/or control device 180, 280, 380 for simulation of the automation and control or of the handling of the different functionalities and services that are available to the respective production module 1, 2, 3. Furthermore, one or more simulation modules for electronics assemblies or modules 182, 282, 382 is present in each of the production modules 1, 2, 3 which, for example, simulate the operation of actuators as well as other electronic, optical and other devices. In addition, each of the production modules 1, 2, 3 includes simulation models for mechanical elements 184, 284, 384.

The arrows 190, 192, 194, 196 shown in FIG. 4 represent an example of a communication sequence for changes in the first production module 1. To this end, for example, the second production module 2 registers itself via a corresponding message 190 with the first production module 1 as a “subscriber”, i.e., as a module linked to the first production module 1, This registration can occur, for example, during the coupling or directly after the coupling of the two modules or also later. In the same way, the third production module 3 registers itself via a corresponding “subscriber” message 192 with the first production module 1. During changes in the first production module, for example, a change of status from a normal status to a stop status, which will then be stored in the status information 170 of the first production module 1, the first production module 1 then sends a corresponding change message 194 to the second production module 210 and also a corresponding message 196 to the third production module 1 in this way, the second and third production module 2, 3 are informed about the change of status in the first production module 1 and can take account of this, for example, during the coordination of a production chain or during joint working on or handling of a product.

A communication scheme of this type is able to insure in principle that during changes in one of the production modules 1, 2, 3, the production modules linked directly or also indirectly are each informed and that this can be taken into account within the framework of the interaction within the plant layout AL. A corresponding subscription process can then be set up analogously in exactly the same way from the first and third production module 1, 3 to the second production module 2 or from the first and second production module 1, 2 to the third production module 3, so that, via such a mechanism, all three of the production modules 1, 2, 3 shown in FIG. 4 mutually inform each other accordingly about changes.

The production modules 1, 2, 3 can be simulated in such cases, for example, as “Cyber-Physical Modules” (CPM), or also as “Cyber-Physical Production Modules” (CPPM).

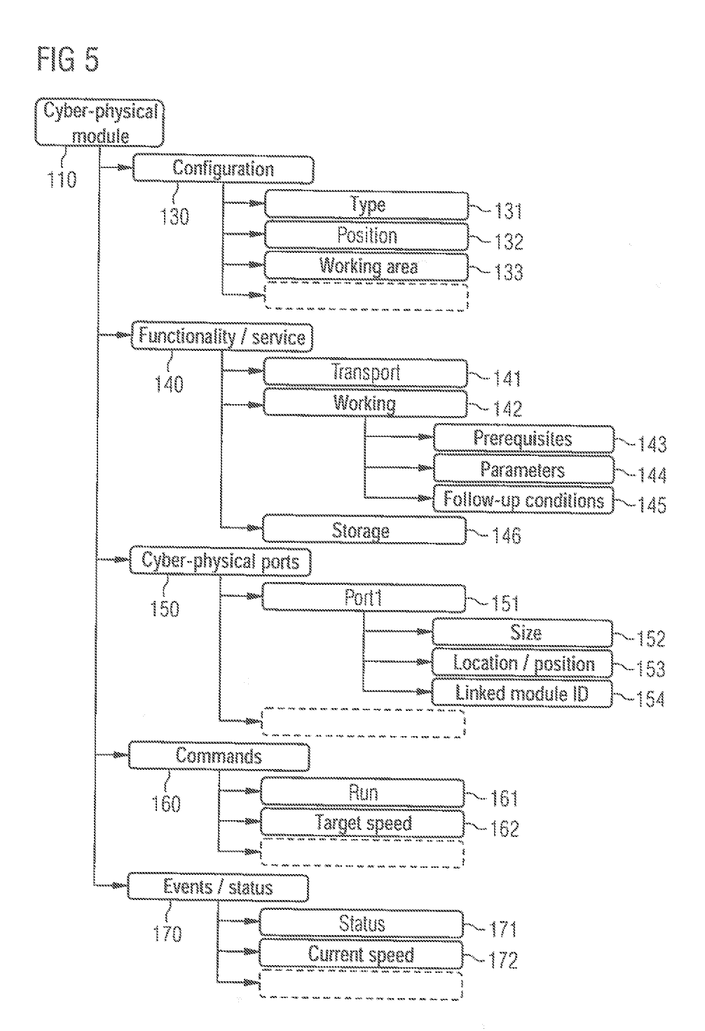

FIG. 5 shows the example for a schematic layout of the self-description information 120 of the first production module 1 shown in FIG. 4. The memory of the self-description information 120 includes configuration information 130 in which, for example, a module type 131, a geometrical location or arrangement 132 of the module or of function elements of the module and also a working area 133 of the module 110 is stored. In this case, the “type” 131 can consist of a corresponding code or also consist of one or more function designations or can include this type of information for example. A spatial area can be described, for example, in the information about the working area 133, in which products can be present in the corresponding production module 1 or within which these products can be moved. Thus, for example, a working area of a transport belt can be a volume area extending along the transport belt, in which the product can be moved with the aid of the transport belt. For a processing machine, the working area can be the volume area in which a processing element of the machine, can act on a product located in the area for example. Corresponding working areas can be established for further functionalities within the framework of the production functions described, here.

Furthermore, the storage area of the first self-description information 120 of the first production module 1 includes functionality and service information 140, where this information includes further information about transport options 141 with the module, processing options 142 of the module or also storage options 146 for warehousing or storage of products or materials. The working information 142 can, for example, further include information about prerequisites for using the corresponding processing functions 143, corresponding parameters, which identify the processing functions more closely 144 and/or &so subsequent conditions 145, which are characterizing or necessary for a further handling of the product after it has been processed.

In quite general terms, a production module in accordance with the present description can in each case also include several of the production functionalities, where information can then be stored or is stored in a corresponding memory device for each of the functionalities, for example. Thus, for example, a production module can have a number of transport functionalities, for example, using one or more transport belts or robot arms or using a combination thereof, can have different processing functions and can also have different storage options.

Furthermore, port information 150 about a “Cyber-Physical Port” to a further production module is stored in the memory device of the self-description information 120 of the production module 1. This “Cyber-Physical Port” can include both information about a functional collaboration of coupled production modules, and also information about the functionalities available in the modules coupled in this way.

Thus, for example, the port information 150 contains information about a first “Cyber-Physical Port” 151 to a neighboring, coupled production module, such as the second production module 2 in accordance with FIG. 4. In this case, the corresponding port information 151 contains, for example, information about a size of the interaction or handover area 152 to the second production module 2, a location or position of the handover area 153, as well as an identification 154 of the linked module. Furthermore, for example, information about a functionality of the second production module 2 as well as information about functionalities of further production modules linked to the second production module 2 can be stored in the corresponding port information 151. Were a further direct connection to exist from the first production module 1 to a further production module, for example, the third production module 3 in accordance with FIG, 4, then corresponding port information would also be stored in the general port information 150 for this corresponding “Cyber-Physical Port” to the third production module 3.

Furthermore, the memory area of the self-description information 120 of the first production module 1 includes information 160 about instructions or commands able to be used in the production module for control of the module. Thus, for example, information is stored in this command memory 160 about a Run command 161 or also about a Target-Speed command 162, with which these commands with parameters able to be used with them are defined and which can be read out by user of the system for creating a control for the first production module 1.

Information about the current status of the production module 171 as well as, for example, about the current speed of a motor of the module 172 is stored in the event/status information area 170 in the memory device 120 of the first production module 1, for example.

The totality of the information stored in the first production module 1 in accordance with FIG. 5 makes it possible, even with a relatively small involvement of a user, or even without the involvement of a user, to organize a simulation of the collaboration of a number of such production modules and to make a joint production sequence of such coupled production modules in a plant layout AL visible. Via the information, it is possible for a further module coupled to such a production module to recognize both information about functionalities of the geometry, and also about the status and the activation or control options of a module as well as the coupling options to the module and to take account of this, for example, in a semi-automatic or even automated planning process.

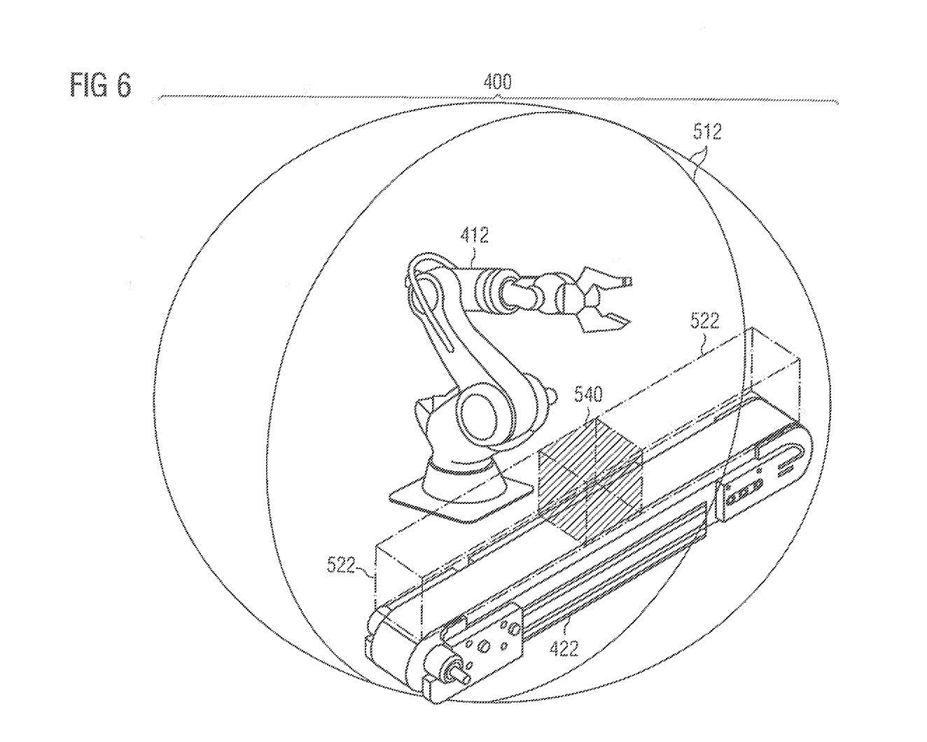

FIG. 6 represents a small extract from a larger production system 400, where this extract comprises a robot 412 and also a transport or conveyor belt 422. In this case, a working area 522 for the transport or conveyor belt 422 is shown in FIG. 6, within the volume area of which a product is able to be transported. The information about the working area 522 can be stored, for example, within corresponding configuration information in a memory of the transport belt 422. Furthermore, a working area 512 of the robot arm 412 is spanned by circular lines, which identify a spherical working area for the robot arm 412. Also shown in FIG. 6 is an interaction area 540 between the transport belt 422 and the robot arm 412, within which a product must be located so that it can be transferred by the robot arm 412 to the transport belt 422 or can be picked up by the robot arm 412 from the transport belt 422.

The information about this interaction area can then be stored, for example, in a memory device of the production module configured for the transport belt 422 and/or in a memory area of the production module configured for the robot arm 412. The interaction area 540 can be established, for example, during the coupling of the robot arm 412 with the transport belt 422. If the geometrical location between robot arm 412 and the transport belt 422 is changed, then a changed interaction area 540 can also be established. The interaction area can be established, for example, as explained in greater detail in the present description.

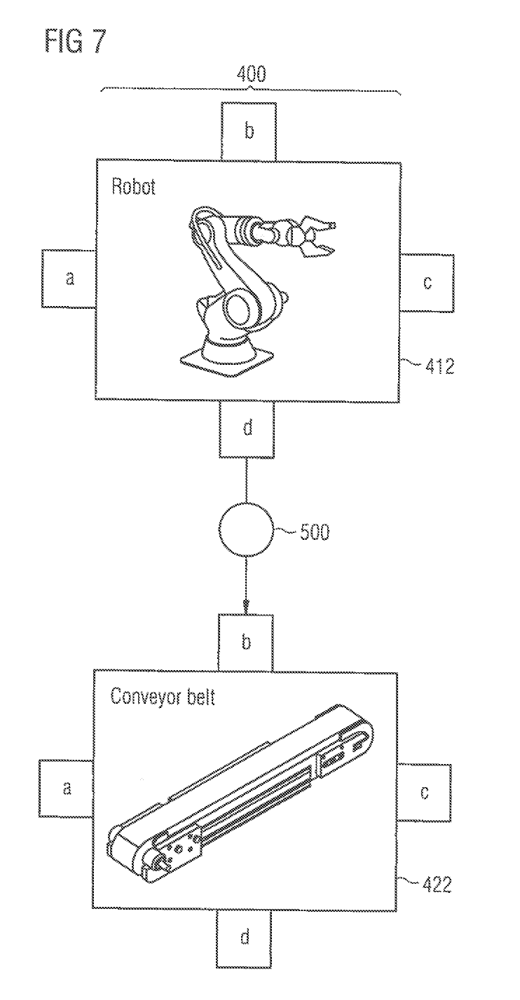

The coupling of the transport belt 422 to the robot arm via the interaction area 450 is able to be described for example as a “Cyber-Physical Port” of the transport belt 422 to the robot arm 412. In exactly the same way, from the standpoint of the robot arm 412, the coupling to the transport belt 422 via the interaction area 540 is able to be described as a corresponding “Cyber-Physical Port”, This is represented in a schematic manner in FIG. 7.

FIG. 7 shows a schematic representation of the robot arm 412 and also a schematic representation of the transport or conveyor belt 422. In this case, the “Cyber-Physical Port” 412/d, from the standpoint of the robot 412 in relation to the transport belt 422 is designated as a square with the designation “d” in FIG. 7. In exactly the same way, the “Cyber-Physical Port” 422/b, as seen from the transport belt 422 to the robot 412, is represented as a square with the designation “b” on the schematic representation of the conveyor belt 422. Furthermore, in FIG, 7 further potential “Cyber-Physical Ports” of the robot arm 412, 412/a, 412/b, 412/c are shown, which represent corresponding “Cyber-Physical Ports” 412/a, 412/b, 412/c to neighboring modules not shown in FIG. 7, or symbolize corresponding memory devices for corresponding port information. In the same way, further “Cyber-Physical Ports” 422/a, 422/c, 422/d are also shown for the conveyor belt 422, which symbolize potential “Cyber-Physical Ports” to further production modules not shown in FIG. 7, or also symbolize memory areas for corresponding port information.

Furthermore, a product 500 to be transferred from the robot 412 to the transport belt 422 is shown in FIG. 7. The schematic diagram of this is shown such that the product 500 will almost be brought into the “Cyber-Physical Port” 412/d of the robot 412 to the conveyor belt 422 by the robot and will then be accepted in the “Cyber-Physical Port” 422/b of the conveyor belt, in order to then be transported further by the conveyor belt 422 for example.

In this case, the two items of port information 412/d and 422/d describe at least inter alia the same spatial interaction area, in order to be able to realize a corresponding product handover,

FIG. 8 shows an example for a schematic sequence during the coupling of two production modules which, for example, can be configured in accordance with the present description or in particular in accordance with the production modules shown in FIGS. 4 to 7.

In a first step 610 a new production module will be associated with an already placed production module. This association 610 can be initiated, for example, via a manual user intervention, such as via a corresponding touchscreen of the modules or a corresponding network connection, or also by corresponding proximity or similar sensors, which recognize the new production module as being neighboring to production modules already placed. The associated production modules thus become neighbors and register themselves via corresponding communication means as such with the other production module in each case. Through this mutual registration one of the effects that can at least be achieved is that corresponding changes to each of the production modules will be notified to the other production module in each case. This can be achieved for example via a subscription communication mode, as has been explained in conjunction with FIG. 4.

In an alignment step 620, a topological alignment of the positions and working areas of the production modules will then be achieved or configured. This can occur, for example, by using a coordinate system of the already installed module. Depending on the available technology this can occur fully automatically (e.g., with the aid of a corresponding positioning system and so-called “Near Field Communication” or also RFID technology). Furthermore the modules can for example also instruct an operator, e.g., via a corresponding control panel, as to how the new module must be moved or aligned, for example.

Such an alignment can be achieved more easily if a corresponding grid or mesh structure is defined for the entire production system, as will be explained in greater detail in conjunction with FIG. 9.

In a calculation step 630, there is an automatic calculation of the “Cyber-Physical Ports”, which includes, inter ails, the calculation of an intersection volume between the working areas of the two modules. Such an intersection volume is an example of an interaction area in accordance with the present description. The information about the respective working areas of the individual modules is stored in the respective modules and will also be transferred by the modules to other modules, In this way, the module already installed can learn from the new module the modules working area and can then, using the knowledge of its own working area and a relative positioning, calculate the intersection volume. If the result of the calculation is that the two working areas do not overlap, then the corresponding production modules, as a rule, cannot simply be coupled functionally with one another.

In a fourth information exchange step 640, there is an exchange of the corresponding service information relating to the properties of the respective production modules to the other production module. Via the registration and publication mechanism already explained in conjunction with FIG. 4, for example, the already placed production module can have the information relating to properties of the new production module transmitted to it, store this information in itself and if necessary pass it on to further production modules already linked to the already placed production module, The information about the functionality or the properties or identification of the new production module can then be stored, for example, in the port information of the placed production module relating to the new production module.

In a harmonization step 650, there is then a harmonization of the functionality of the already installed production module with the newly placed production module, in order to make it possible for the functionalities of the two production modules to interact, Such a harmonization can, for example, include the adaptation of transport speeds of two transport belts linked to one another or also the adaptation of a transport speed to a working process to be performed or similar. After conclusion of the collaboration step 650, the new production module and the already placed production module can collaborate in relation to simulated working on and production of a product.

FIG. 9 shows two examples for spatial regular arrangements of the production system 400, where the complete production system 400 is now shown in FIG. 9. In a first square grid structure of the production system 400/1, each of the production modules is located within a square surface area. In this case, the production system 400 comprises two 3D printers 411, 431, two robots 412, 432 as well as two Computerized Numerical Control (CNC) machines 413, 433. Furthermore, the production system comprises a feed and transport unit 421 for the product, a transport or conveyor belt for the product 422 and also a transport and storage unit 423.

The spatial embodiment of the respective module outline enables the individual production modules to be formed such that they are located entirely within the corresponding square surface area and also the distances to the edges of the respective square cells are known. Thus, already during the software development of the individual production modules, corresponding mechanical elements for transport or for working on the products can be prepared so that a collaboration with a neighboring square cell is possible.

FIG. 9 further shows an alternate embodiment of the production system as hexagonal honeycomb system 400/2, in which the production modules of the production systems 400 are formed in a respective hexagonal cell arrangement and are assembled to form a production system.

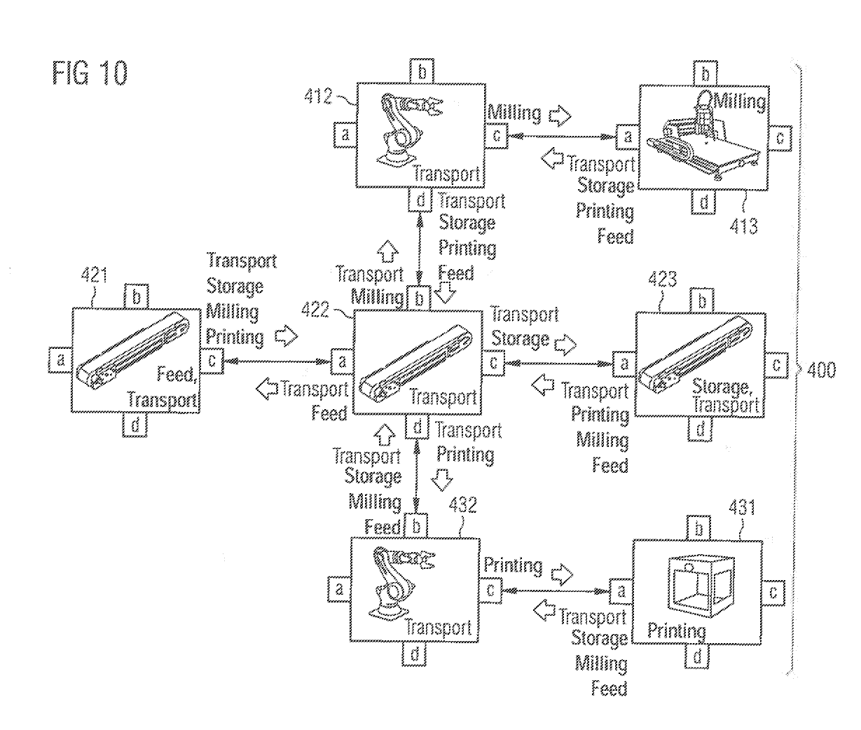

FIG. 10 represents an extract of the production system 400 shown in FIG. 9 and shows a more functional representation. In FIG. 10 the production system 400, by contrast with FIG. 9, is shown with only one 3D printer 431 and also only one CNC milling machine 413.

The individual production modules are shown symbolically in FIG, 10, where, for each of the production modules, four “Cyber-Physical Ports” a, b, c, d are shown as appended, small squares, which symbolize a possible or also existing “Cyber-Physical Port”.

Thus, for example, the transport or conveyor belt 422 has four existing “Cyber-Physical Ports” 422/a, 422/b, 422/c, 422/d. In this case, the “Cyber-Physical Port” 422/a to the feed transport module 421 symbolizes the “Cyber-Physical Port” to this module, The information stored in relation to this “Cyber-Physical Port” 422/a also includes ail functionalities, which are able to be reached via this “Cyber-Physical Port”. These reachable functionalities are written in FIG. 10 as text next to the respective square symbol of the “Cyber-Physical Ports”. Thus, inter alia, the “Cyber-Physical Port” 422a includes the information, that via this port, i.e., this connection, to the feed/transport module, the functionalities: “Transport” and “Feed” are able to be reached, which can be executed by the corresponding module 421, The functionalities “Transport” and “Milling” are available via the port 422/b of the transport module 422 to the robot 412, for example, which are then stored in the corresponding port information 422/b. Here, the “Transport” functionality will be performed by the robot 412, while the “Milling” functionality will be performed by the CNC milling machine 413 linked to the robot 412.

In this way, for example, all functionalities (except for its own) of the production system 400 are available via the port 4211c of the feed, transport modules 421 (i.e. via the widest variety of paths the functionalities “Transport”, “Storage”, “Milling” and also “Printing”).

In this way, with a product located in a specific production module, and known working steps required next, by analysis of the port information of the respective module in each case, if required a production sequence for further production of the can be determined.

The organization of the individual function information about the linked production modules stored in the ports can, for example, be achieved via an information distribution step, as has been explained, for example, in FIG. 8 in conjunction with step 840. Via a change forwarding mechanism, as explained for example in conjunction with FIG. 4, the respective information can then be kept up-to-date.

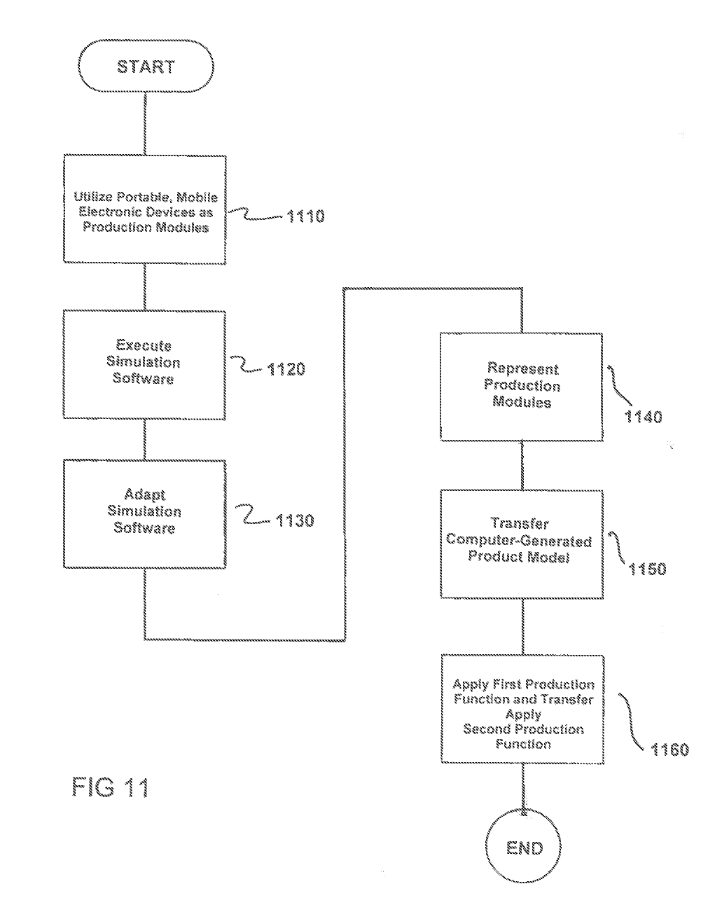

FIG. 11 is a flowchart of a method for simulation of an industrial production plant, where a plurality of production modules 1, . . . ,n is assembled to form a plant layout AL of the production plant to be simulated, The method comprises utilizing portable, mobile electronic devices with a display unit I) as production modules 1,. . . ,n, as indicated in step 1110.

Next, simulation software S is executed on the mobile electronic devices, as indicated in step 1120.

Next, the simulation software S is adapted by a user input on a respective device to production-specific features of the production module 1, . . . ,n representing this device, as indicated in step 1130.

A first production module 1 by a simulation is now represented on a first device and a second production module 2 is now represented by a simulation on a second device, as indicated in step 1140.

Next, a computer-generated product model 40 is transferred to the first production module 1 to simulate a production sequence, as indicated in step 1150.

Next, a first production function is applied to the product model 40 and transferring the product model 40 to the second production module 2, and a second production function is applied to the product model 40 in the second production module 2 in accordance with the production-specific features of the first production module 1, as indicated in step 1160.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention, For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for simulation of an industrial production plant, a plurality of production modules being assembled to form a plant layout of the production plant to be simulated, the method comprising:
utilizing portable, mobile electronic devices with a display unit as production modules;
executing simulation software on the mobile electronic devices;
adapting the simulation software by a user input on a respective device to production-specific features of the production module representing this device;
representing a first production module by a simulation on a first device and representing a second production module by a simulation on a second device;
transferring a computer-generated product model to the first production module to simulate a production sequence; and
applying a first production function to the product model and transferring the product model to the second production module, and applying a second production function to the product model in the second production module in accordance with the production-specific features of the first production module.

2. The method as claimed in claim 1, wherein each portable, mobile electronic device includes a left contact side, a right contact side, an upper contact side and a lower contact side and the plant layout being defined by:
a) positioning the first production module at a first position, a coordinate origin being formed by this first position of the first production module;
b) displaying possible contact sides via a touch object on the display unit of the first production module depending on the production-specific features of the first production module;
c) positioning the second production module as a neighbor to the first production module, possible contact sides of the second production module being displayed on the display unit via a further touch object depending on the production-specific features of the second production module, such that a contact side of the second device marked by a touch object is placed against a contact side of the first device marked by a touch object;
d) actuating both touch objects from the contact sides now facing towards each other to define a second position of the second production module in relation to the coordinate origin; and
f) positioning the further production modules in a similar manner to that described in step c) and d) until the desired plant layout is reached.

3. The method as claimed in claim 1, wherein for coupling of the first production module with the second production module, first self-description information relating to the production-specific features of the first production module is stored in the first production module and second self-description information relating to the production-specific features of the second production module is stored in the second production module, the method further comprising:
coupling the first and second production module;
transmitting the second self-description information of the second production module to the first production module; and
establishing first port information relating to the coupling with the second production module by the first production module and storing the first port information in the first production module,

4. The method as claimed in claim 2, wherein for coupling of the first production module with the second production module, first self-description information relating to the production-specific features of the first production module is stored in the first production module and second self-description information relating to the production-specific features of the second production module is stored in the second production module, the method further comprising:
coupling the first and second production module;
transmitting the second self-description information of the second production module to the first production module; and
establishing first port information relating to the coupling with the second production module by the first production module and storing the first port information in the first production module.

5. The method as claimed in claim 3, wherein, after the coupling of the first and second production module, the method further comprising:
transmitting at least one of (i) the first self-description information of the first production module and (ii) the first port information to the second production module; and
establishing second port information relating to the coupling with the first production module by the second production module and storing said established second port information in the second production module

6. The method as claimed in claim 3, wherein the establishing at least one of (i) the first second port information and (ii) the second port information includes establishing information about a spatial interaction area of the first production module with the second production module, wherein the spatial interaction area is formed such that both the first production function of the first production module and the second production function of the second production module act on the product model when it is located in the interaction area.

7. The method as claimed in claim 5, wherein the establishing at least one of (i) the first second port information and (ii) the second port information includes establishing information about a spatial interaction area of the first production module with the second production module, wherein the spatial interaction area is formed such that both the first production function of the first production module and the second production function of the second production module act on the product model when it is located in the interaction area

8. The method as claimed in claim 2, wherein the self-description information comprises at least one of:
(i) service information relating to the production function,
(ii) configuration information relating to at least one of (a) a location of the production module and (b) an embodiment of the production module,
(iii) capability information relating to available functions and services of the production module, which includes information about the production function,
(iv) command information relating to executable commands and parameters settable by the production module, and
(v) status information relating to a working status of the production module.

9. The method as claimed in one of claim 1, wherein, when the simulation has reached a target status, the parameters and the settings obtained during the simulations of at least one of the following items of information:
(i) the self-description information,
(ii) the service information,
(iii) the configuration information,
(i) the capability information,
(iv) the command information, and p1 (v) the status information,
is stored and used for a subsequent real production with a real production plant and real production modules.

10. A computer program product for simulation of an industrial production plant, which is stored on a non-transitory computer-readable medium and including program instructions which, when executed by a mobile device cause simulation of the industrial production plant, the program instructions comprising:
program code for utilizing portable, mobile electronic devices with a display unit as production modules;
program code for executing simulation software on the mobile electronic devices;
program code for adapting the simulation software by a user input on a respective device to production-specific features of the production module representing this device;
program code for representing a first production module by a simulation on a first device and representing a second production module by a simulation on a second device;
program code for transferring a computer-generated product mod& to the first production module to simulate a production sequence; and
program code for applying a first production function to the product model and transferring the product model to the second production module, and applying a second production function to the product model in the second production module in accordance with the production-specific features of the first production module.
